(19) United States
(12) Patent Application Publication
(10) Pub. No.: US 2010/0106719 A1
(43) Pub. Date: Apr. 29, 2010

(54) CONTEXT-SENSITIVE SEARCH

(76) Inventors: DEBORA DONATO, Barcelona (ES); ARISTIDES GIONES, Barcelona (ES)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/257,211

(22) Filed: Oct. 23, 2008

(51) Int. Cl. G06F 17/30

(52) U.S. Cl. 707/728; 707/E17.014; 707/E17.015

(57) ABSTRACT

A method for performing a search based on a query term and a context document is described herein. The method involves receiving a search request comprising a query term and a context document, and identifying a target document of a plurality of documents based on a relationship of the context document with the target document and the query term, where the relationship of the context document with the target document is determined prior to receiving the search request.

### FIELD OF THE INVENTION

The present invention relates to search technologies in general. More specifically, the invention relates to contextual search technologies.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

One of the most common tasks in information search and retrieval is the task of keyword search. A keyword search involves submission of query term(s) as a set of keywords by a user with the goal of receiving a ranked list of documents (or references to the documents) from a document collection based on relevance to the query term.

However, a query term may not be sufficient to identify relevant search results. For example, a word orange may refer to the color orange, the fruit orange, or a book titled Orange. In order to better identify relevant search results, a context document being viewed by the user, when the user initiates the query, may be used to better identify relevant search results.

For example, when a user initiates a query by entering a query term while viewing a webpage, the webpage may also be used to identify relevant search results. The webpage is used by extracting keywords from the webpage, and providing the user entered query term with the keywords from the webpage to better identify search results.

However, determining a suitable selection of keywords from the webpage for use in the search may be difficult. Furthermore, the limited selection of keywords from the webpage may not take into account different known attributes of the webpage (or other context document) such as links to and from the webpage, a categorization of the webpage, author of webpage content, etc.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating an embodiment for searching based on a query term and document relationships with a context document.

FIG. 2 is a flow diagram illustrating an embodiment for creating a linked structure representing a set of documents and the predetermined relationships between the documents.

FIG. 3 is a flow diagram illustrating an embodiment for performing a search using predetermined document relationships.

FIG. 4 is a flow diagram illustrating an embodiment for determining weighted feature vectors.

FIG. 5 is a flow diagram illustrating an embodiment for searching based on a query term and a relationship between the query requester and the authors of the search results.

FIG. 6 is a block diagram illustrating a computer system that may be used in implementing an embodiment of the present invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Several features are described hereafter that can each be used independently of one another or with any combination of the other features. However, any individual feature might not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in the specification.

### Overview

A method for searching based on a query term and a context document is provided. A context document received as part of a search may be related to many other documents through links, common associations such as geographical locations, user browsing history, common categorization, etc. In order to perform a search these predetermined relationships with other documents may be exploited to obtain more pertinent search results that are related directly or indirectly to the context document.

The method uses predetermined relationships between the context document and a plurality of documents to rank or filter search results that may be obtained based on a query term. Accordingly, at least one target document is identified based on the query term and a predetermined relationship of the context document with the target document.

The predetermined relationships between documents may be captured in data structures. The data structures can be searched to find the documents that are already determined to be related to a context document that is received as part of a search request. For example, the relationship of the context document and the plurality of documents may be used to perform the search. Each of the documents may be represented with a corresponding node in a linked structure and one or more relationships between different documents may be represented with an edge between the corresponding nodes. The node relationships within the linked structure may then be used to identify the predetermined relationship of the context document with the target document when the context document is received as part of a search request.

Although specific components are recited herein as performing the method steps, in other embodiments, agents, or mechanisms acting on behalf of the specified components may perform the method steps. Further, although the invention is discussed with respect to components distributed over multiple systems (e.g., an interface on a client machine and a search engine on a server), other embodiments of the invention include systems where all components are on a single system (e.g., a search for documents on a personal computer). Furthermore, embodiments of the invention are applicable for searching any set of documents with predetermined relationships (e.g., obtained over a network, a local machine, a server, a peer machine, within a software application, etc.).

While specific embodiments of the invention are described in which search results are filtered or ranked based on document relationships, the techniques described herein are not limited to the disclosed embodiments of the invention and the techniques described herein may be applicable to other embodiments.

### System Architecture and Functionality

Although a specific system architecture is described to perform an embodiment of the invention, other embodiments of the invention are applicable to any architecture that can be used to perform a search using, at least in part, predetermined relationships between documents.

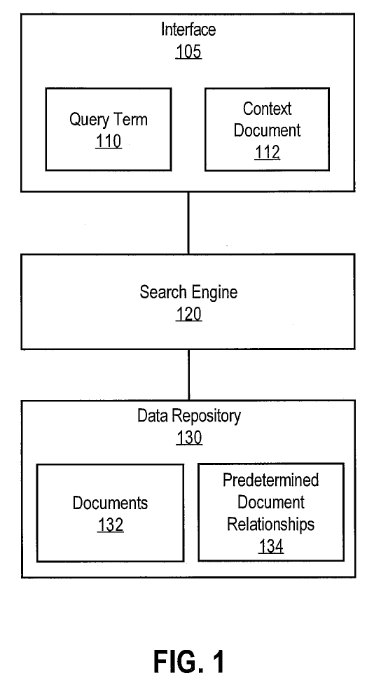

FIG. 1 shows a system architecture in accordance with one or more embodiments. As shown in FIG. 1, the system includes an interface (105), a search engine (120), and a data repository (130).

In an embodiment, the interface (105) corresponds to any sort of interface adapted for use to access the search engine (120) and any services provided by the search engine (120). The interface (105) may be a web interface, graphical user interface (GUI), command line interface, or other suitable interface which allows a user to perform a search. The interface (105) may be displayed on a client machine (such as personal computers (PCs), mobile phones, personal digital assistants (PDAs), and/or other digital computing devices of the users) or may be accessed remotely in conjunction with a client machine to provide a search criteria to the search engine (120). For example, the interface (105) may be a part of a web browser application or simply an application for browsing and/or searching local files on a client machine or local network.

In an embodiment, the interface (105) allows for input of a search criteria to perform a search. The search criteria includes at least a query term (110) and a context document (112). The query term (110) generally represents any keywords, numbers, characters, symbols, selections, etc. that may be entered by a user to search for a document. The context document (112) generally represents any document that provides context for the search. The context document (112) may be a document actually provided by the user or may simply represent a document being displayed in the interface (105) when the search was initiated. For example, if a user is viewing the USPTO website and types in a term “amendment” into a search toolbar, then the query term received is “amendment” and the context document received is the USPTO website webpage being viewed by the user. The context document (112) may also be the last document viewed by a user before the user initiated the search. In another example, the interface may include two different input fields where in one field the user may enter the query term (110) and in the second field the user may provide the context document (112), provide a link to the context document (112), or otherwise indicate the context document (112) to be used for performing the search.

In one or more embodiments of the invention, the data repository (130) generally represents any data storage device (e.g., local memory on a client machine, multiple servers connected over the internet, systems within a local area network, a memory on a mobile device, etc.) known in the art which may be searched based on a search criteria (e.g., a query term (112) and a context document (120)) to obtain search results. Elements or various portions of data shown as stored in the data repository (130) may be stored in a single data repository or may be distributed and stored in multiple data repositories (e.g., servers across the world). In one or more embodiments of the invention, the data repository (130) includes flat, hierarchical, network based, relational, dimensional, object modeled, or data files structured otherwise. For example, data repository (130) may be maintained as a table of a SQL database. In addition, data in the data repository (130) may be verified against data stored in other repositories.

In one or more embodiments, the data repository (130) includes documents (132) and predetermined document relationships (134). The documents (132) generally represent text, images, video, etc. in any format that can be referred to (e.g., by title, by identification number, by author, by date, etc.) Examples of documents (132) may include but are not limited to web pages, web postings, books, articles, blogs, spreadsheets, slides, text documents, images, etc. In one or more embodiments, the predetermined document relationships (134) generally represent any sort of relationship between the documents that is determined prior to receiving a search request. Examples of predetermined document relationships may include but are not limited to hyperlinks between documents, common authors, common geographical locations associated with two or more documents, a common categorization, a relation to or a creation within a common time period, etc. For example, two documents (132) may have a predetermined document relationship (134) such that one document includes a link to the second document or each of the documents include a link to the other document. Another example, may involve two documents where one document may be linked to another document by traversal of multiple hyperlinks through intermediate documents. Further, the predetermined document relationships (134) may correspond to a common browsing history. For example, the predetermined document relationship (134) between a set of documents (132) may be that each of the related documents (132) have been accessed by the same user or one or more employees of the same company. In an embodiment, a predetermined document relationship (134) may involve a common publication company. For example, a predetermined document relationship (134) may involve a set of law school publications for a single law school, or for a group of law schools (e.g., ABA approved law schools). Accordingly, a context document (112) that is a law school publication may have a predetermined relationship with other documents (132) that are also law school publications.

Continuing with FIG. 1, the search engine (120) generally represents hardware and/or software that can be used to search the data repository (130) based on a search criteria (e.g., query term (110) and context document (112)) received via the interface (105), in accordance with an embodiment. The search engine (120) may be implemented locally or remotely. For example, in a single system, the search engine (120) may be implemented on the same client system as the interface (105) itself. In a network, the search engine (120) may be implemented on a server. The search engine (120) may include logic to determine which of the documents (132) corresponds to the context document (112) and further search for target documents of the documents (132) that both match the query term (110) and are related to the context document (112) based on one or more document relationships (134).

The documents (132) and predetermined document relationships (134) may be implemented using any suitable data structure such as, for example, a linked structure, a table, a tree, an array, etc. However, in order to provide a detailed example, the disclosure below describes one possible implementation using a linked structure to store predetermined document relationships (134) and search for target documents of the documents (132) based on the predetermined document relationships (134) and a context document (112).

### Creating a Linked Structure Representing Document Relationships

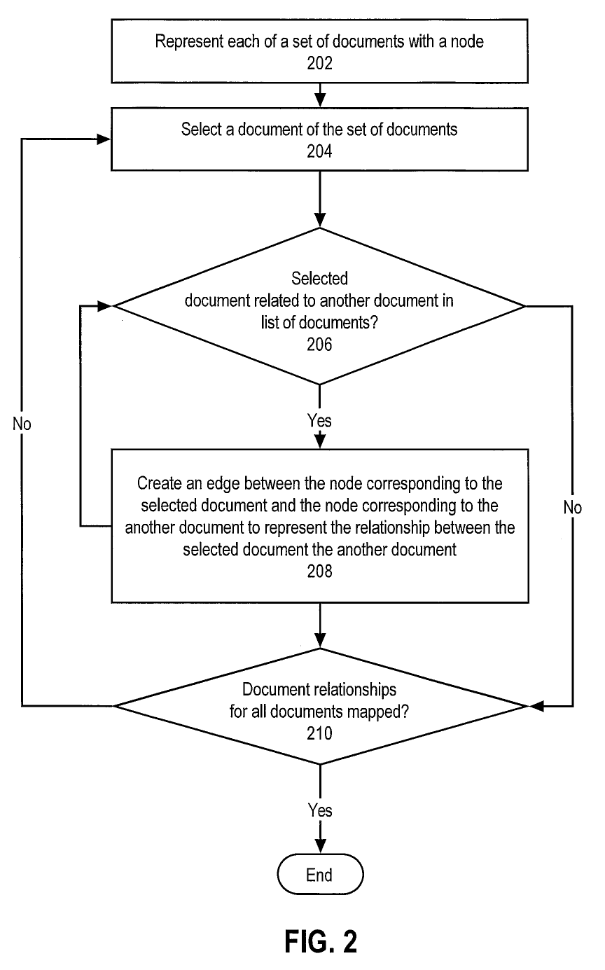

FIGS. 2-5 show flow charts related to storing predetermined document relationships and performing searches using a context document and a query term in accordance with one or more embodiments. One or more of the steps described below may be omitted, repeated, and/or performed in a different order. Accordingly, the specific arrangement of steps shown in FIGS. 2-5 should not be construed as limiting the scope of the invention. Further, the steps shown below may be modified based on the data structure used to store the document relationships and search for documents based on the context document.

FIG. 2 shows a flow chart for creating a linked structure representing a set of documents and the predetermined relationships between the documents. Initially, each of the set of documents is represented with a node (Step 202). Representing each of the documents with a node may be done sequentially in order of receipt of the documents, or in any other suitable manner (e.g., alphabetized titles order). Next a document of the set of documents is selected (Step 204) and a determination is made whether the selected document is related to any of the other documents in the set of documents (Step 206). This determination may be made using the document itself or metadata associated with the document. For example, if the metadata associated with each document includes a document author, then the document author for the selected document may be compared to the document author for other documents within the set. In another example, if the selected document is a webpage, then the document may be read in as input and tokenized to search for hyperlinks. Each of the hyperlinks may be identified as indicating a document relationship to a corresponding hyperlinked webpage. If a predetermined document relationship relating two documents within the set of documents is identified, then an edge or other suitable indication of the relationship is created between the node corresponding to the selected document and the node corresponding to the related document (Step 208). For example, if a determination is made that one document contains a hyperlink to another document, then an edge representing the hyperlink is created between the two corresponding nodes representing the documents. In an embodiment, the type of relationship between two documents may be stored in addition to the fact that the two documents are related. For example, different edge values may be used to specify the different types of document relationships described above. In an implementation using tables to record document relationships between documents, the table values may specify the type of document relationship. Furthermore, the edges may also include directional information. For example, a one-sided arrow edge (or pointer) may be used where one document hyperlinks to another document and a two-sided arrow edge (pointer in both directions) may be used where documents hyperlink to each other. In an embodiment, indirect relationships between documents may also be represented with edges. For example, if a document may be reached by traversing three different hyperlinks from another document, then an edge representing the indirect relationship of the documents may be created and the value of the edge may indicate the number of hyperlinks, h, needed for traversing between the documents.

Next a determination is made whether the document relationships for all of the documents have been mapped (Step 210). If additional documents are left, then the process is repeated for the additional documents. If the document relationships that are to be mapped have been completed for each of the documents, then the process is complete, thereby creating a linked structure where each of the documents are represented by nodes, where document relationships are represented with edges.

In an embodiment, the process described above is used with document clustering where each node described above represents a group of documents. In this embodiment, a context page is represented by a first node that represents a set of documents. Accordingly, a search for a query term based on the context page may involve a search of all the documents represented by the same node as the context page and may further involve a search of document clusters represented by one or more related nodes within the linked structure. The document clusters may be themselves be generated based on predetermined document relationships as described above, or based on content-based similarities between the documents within a group.

### Search using Predetermined Document Relationships

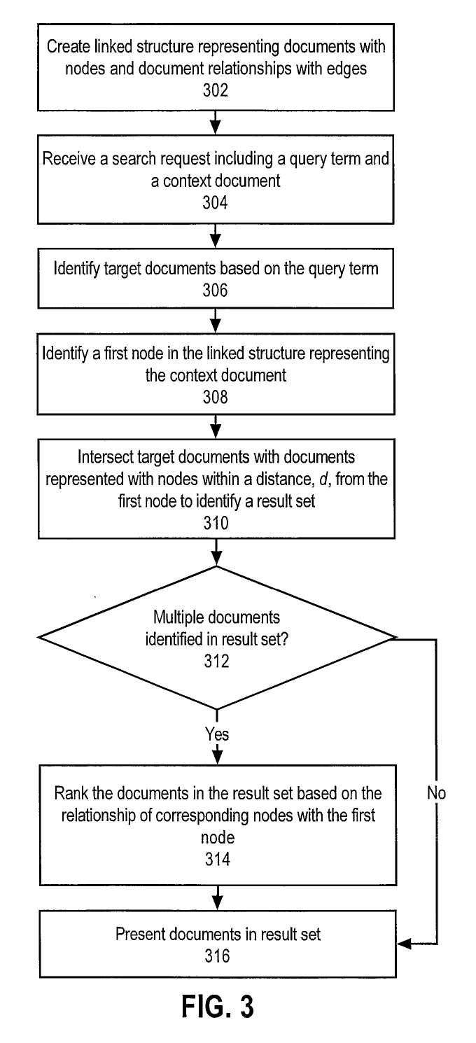

FIG. 3 shows a flow chart for performing a search in accordance with an embodiment using predetermined document relationships. Initially, a linked structure is created, as described above with relation to FIG. 2, where documents are represented with nodes and predetermined document relationships are represented with edges (Step 302).

In an embodiment, a search request including a query term and a context document is received (Step 304). Receiving the context document may involve receiving a soft copy of the document itself or simply receiving a reference to the document (e.g., a web address where the document may be found). Receiving the context document may also refer to a selection of the context document that is already stored on a local server. For example, a context document from a local server that is being displayed to a user when the search request is initiated by the user submitting a query term, may be referred to as receiving the context document.

In an embodiment, based on the query term(s), target documents that include one or more query term(s) are identified using one or more techniques (Step 306). For example, a content based document retrieval approach involving an inverted index may be used to search for target documents based on a mapping of one or more query term(s) to the location of the one or more query term(s) in a database file, document, set of documents, etc. Another example may involve form based document retrieval approval using substring matching algorithms.

In an embodiment, the node in the linked structure representing the context document is identified (Step 308). For example, the node representing the context document may be identified via a web address, document ID number, etc. maintained by the node. In an embodiment, a document represented by a node may be compared to the context document received to determine whether the document represented by the node is the same as the context document. For example, if the context document is an article, then the context document may be compared to documents stored in the data repository to identify a match. Thereafter the node that represents the matching document from the data repository may be deemed as representing the context document.

In Step 310, the documents represented by nodes connected directly or indirectly to the first node may be intersected with the target documents (identified in Step 306) to identify a result set including one or more documents. In an embodiment, selection of the nodes connected directly or indirectly may be limited based on the distance, d, from the first node. For example, if a value 5 is used as a distance, d, then any documents identified within the result set must be represented with a node that can be reached by traversing 5 or fewer edges from the first node representing the context document. The distance d may be static or dynamic. In an example, where each edge between the nodes represents a hyperlink between the documents represented by the nodes, the distance d from the first node to a target node may be equivalent to the number of hyperlinks, h, that have to be traversed to reach the target document from the context document.

In another embodiment, the result set may also be determined by first determining a candidate set of documents represented with nodes within a distance, d, from the first node representing the context document and searching the candidate set of documents for the one or more query term(s), e.g., using string matching algorithms.

If multiple documents are identified in the result set (Step 312), then the documents within the result set may be ranked (Step 314). Documents may be ranked (or filtered out) based, at least in part, on graph-based relationships (also known as graph-based features) or content-based relationships (also known as content-based features) of the corresponding nodes to the first node representing the context document. Detailed descriptions of various graph-based features that may be used in accordance with one or more embodiments are described in greater detail below.

In an embodiment, the target document(s) identified based on the query term and the context document are presented to a user (Step 316). The target document(s) may be presented by displaying, printing, transmitting, emailing, providing a link to, providing a reference to, or otherwise presenting the document in a suitable manner. In an embodiment, a visual display corresponding to the linked structure may be presented to the user so that the user may view how the target document is linked to the context document. For example, all the direct or indirect document relationships from the context document to the identified target document(s) may be presented to the user. Thereby, one or more embodiments of the invention allow for a user to view exactly how a document in a set of search results is related to the context document.

### Graph-Based Features

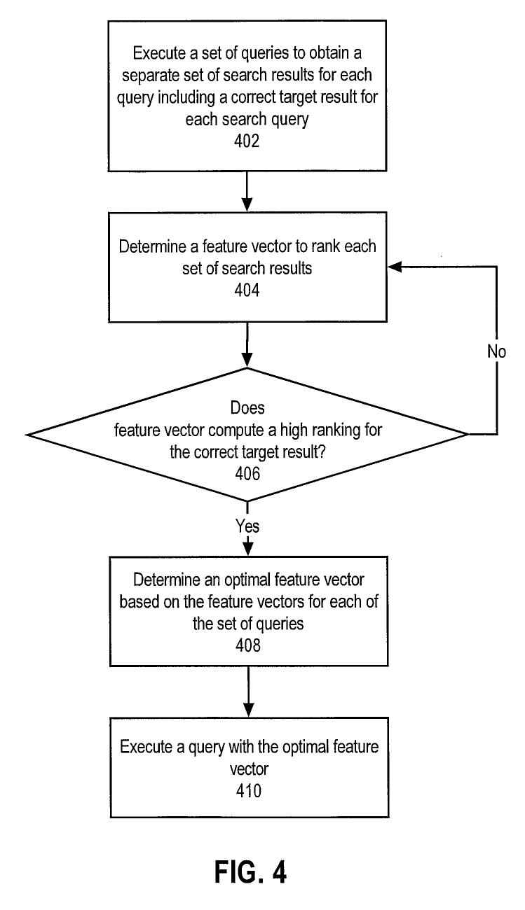

In an embodiment, the documents within a set of search results are ranked based on one or more features. In an embodiment, the features may be weighted when determining a final rank for a search result by combining the values for each feature based on the relationship of a context document (or query node p representing the context document) with a target document (or target node v representing the target document). An example of determining the weight for each feature is described below in relation to FIG. 4. The features may include content-based features or graph-based features. Examples of content-based features include probabilistic relevance measure and textual similarity. Examples of graph-based features include predecessor similarity, successor similarity, spectral distance, PageRank® (PageRank® is a registered trademark of Google, Inc., Mountain View, Calif.), Point-Wise context-sensitive PageRank®, and Cluster-wise context-sensitive PageRank®. For simplicity, the different features will be described in relation to two nodes, i.e., a query node p representing a context document c, and a target node v representing a target document with relation to one possible example, i.e., the Wikipedia® model (Wikipedia® is a registered trademark of the Wikimedia Foundation, Inc., a U.S. registered 501(c)(3) tax-deductible nonprofit charity).

### Features: Predecessor Similarity and Successor Similarity

Predecessor Similarity and Successor Similarity may be determined for two or more nodes in any directed graph. For example, similar predecessors are nodes that directly or indirectly point to the query node p and the target node v in the directed graph. Further, similar successors are nodes that directly or indirectly are pointed to by both the query node p and the target node v in the directed graph.

### Feature: Spectral Distance

Spectral distance is a measurement of the distance between the query node p and the target node v in a graph. One way of measuring the distance between the two nodes in the graph is to construct a spectral embedding of the graph to a low dimensional Euclidean space and consider the distance of the nodes in the low dimensional Euclidean space.

### Feature: PageRank®

PageRank® is a numerical weight assigned to each element of a hyperlinked set of documents, such as the Wikipedia model or the World Wide Web, with the purpose of “measuring” its relative importance within the set. The algorithm may be applied to any collection of entities with reciprocal quotations and references. The PageRank® of a target node, v, is given by the v-th coordinate of the stationary distribution π of a random walk defined on a graph G. π may be expressed as the solution of the recurrence equation: π=□A π+(1−□)t^{T}π, where A is the adjacency matrix of the graph G and t the teleport vector, which can be used to adjust the resulting PageRank®, for example, based on a user's preference. The intuition behind the recurrence equation is the model of a random surfer on Wikipedia®, who follows one of the links on the current page with probability □ or jumps to a random page, sampled from a distribution specified by t, with probability (1−□). In the basic case the teleport vector t is the uniform distribution, i.e., all nodes have the same probability of being the target of a random jump.

### Feature: Point-Wise Context-Sensitive PageRank®

In general, a PageRank® of a target node v may be increased by assigning it a higher probability in t, which may also result in an increase of the PageRanks® in the neighborhood of target node v, specifically nodes pointed to by v.

For a query <q, c>, where q represents one or more query terms and c represents a context document that is represented by query node p in the graph G, the PageRanks® may be modified to take into account the context document c. In order to generate context-sensitive PageRanks® the teleport vector t may be adjusted so that t(p)=1 and t(v)=0, for v≠p. Performing a random walk, following a link in the graph with probability 1−□ results in returning to the query node p. In accordance with one or more embodiments, the resulting stationary distribution with the adjusted teleport vector, as described above, represents the point-wise context-sensitive PageRank® πₚ.

### Feature: Cluster-Wise Context-Sensitive PageRank®

In an embodiment, PageRank® vectors πₚ may be approximated based on the assumption that if two nodes, i and j are close in terms of their distance in the graph G, then the corresponding PageRank® vectors πᵢ and πⱼ will tend to be similar, even though it may not necessarily be true for ever case.

One method for approximating PageRank® vectors πₚ involves the use of random landmarks within the graph G. For example, instead of computing the context-sensitive PageRank® vectors πₚ, for every page query node p, the PageRank® may be computed for a sample (e.g., random sample or evenly distributed sample) of nodes of the graph G, and offline PageRank® scores may be computed for each of the sample pages. Thereafter, the PageRank® for the sample page closest to query node p may be used in place of PageRank® vector πₚ representing the query node p.

Another method for approximating PageRank® vectors πₚ involves the use of graph clustering. In this case, the graph G is portioned into k disjoint clusters and one PageRank® is computed for each cluster C. The PageRank® vector π_{c} for each cluster C may be computed using the recurrence equation: π=□A π+(1−□)t^{T}π, described above, where the teleport vector t is adjusted so that t(p)=1/|C| if p □ C and t(p)=0 otherwise. Accordingly, at a teleport step of a random walk, any node with the cluster C is randomly jumped to. Thereafter, if a query node p is within a cluster C, π_{c} is used instead of πₚ.

In an embodiment, graph G is partitioned such that all nodes within the same cluster have a similar context-sensitive PageRank®, thus the clustering may be based on the link structure of the graph. For example, clustering may be determined based on a spectral distance between nodes.

### Determining Optimal Feature Vectors

FIG. 4 shows a flow chart for determining feature vectors. Feature vectors generally represent a weighting of content-based features (similarities) and graph-based features that is used to rank search results. Graph-based features are based on relationships between nodes in a linked structure, as described above. Content-based features are based on content similarities between the query term and the search result, and content similarities between the context document and the search result.

Initially, a set of queries, each including at least a query term and a context document, is executed to obtain a separate set of search results for each query (Step 402). In an embodiment, the queries reflect different situations and include a number of different contexts for a query string q. Each separate set of search results may include a large of number search results and may further include at least one correct target result. The correct target result for a query may be identified specifically by a user or may be determined based on previous user selections for the respective query.

Next a feature vector is determined for ranking each set of search results (Step 404). Different weight values may be tested for different features within the feature vector until the feature vector, when applied to rank the set of search results, computes a high ranking for the correct target result. In an embodiment, a weighted feature vector may be required such that the correct target result receives the best ranking respective to the set of search results. In an embodiment, the weighted feature vector may also be required to follow other constraints. For example, if a first search result is known to be more relevant to the query term and the context document than a second search result, then the constraint may require that the feature vector, when applied to the set of search results, ranks the first search result higher than the second search result.

Based on the feature vectors determined for each of the queries, an optimal feature vector is determined (Step 408). For example, the optimal feature vector may be determined by applying statistical calculations such as average, median, mode, etc. to the set of feature vectors for the set of queries. The optimal feature vector may then be used to rank one or more additional queries (Step 410).

### Search for User Answers using Predetermined user Relationships

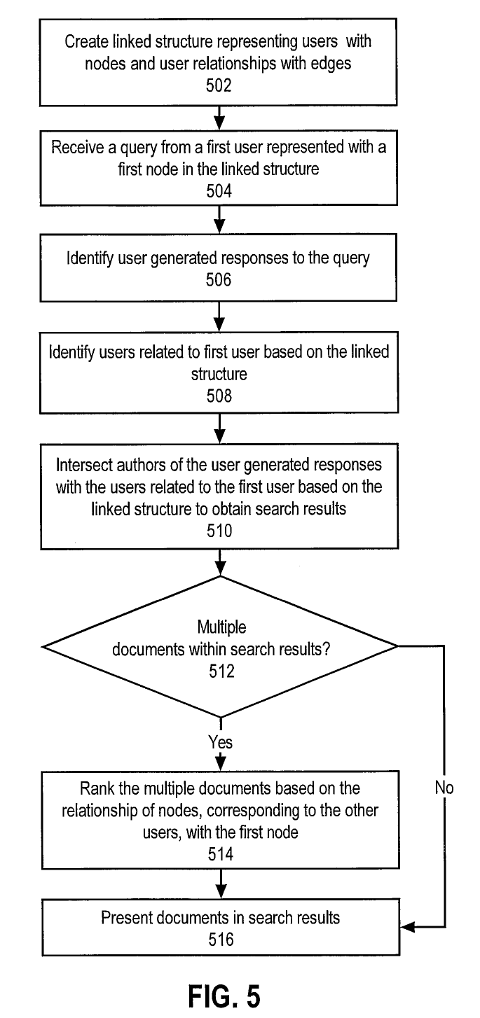

FIG. 5 shows a flow chart for searching based on a query term and a relationship between the query requester and the authors of the search results. Initially, a linked structure is created where each node in the linked structure represents a user, and where edges within the linked structure represent a predetermined relationship between different users (Step 502). The predetermined relationships between different users may be based on the interaction of the users, demographics of the users, associations of the users, etc. For example, the predetermined relationships may relate all users from the same university. Another example may involve a predetermined relationship between users that have previously posted to the same discussions thread (e.g., question and answer on the same thread).

In an embodiment, a query is received from a first user represented by a first node in the linked structure (Step 504). In response a set of user generated responses to the query are identified (Step 506). Next, the users that have a predetermined relationship with the first user are identified (Step 508). In an embodiment implementing the linked structure, the users may be identified by traversing edges from the node representing the first user. An edge limit, e, may be used in selecting users. For example, a value 1 of e results in identification of users that are directly related to the first user, whereas a value 2 of e results in identification of a first set of users that are directly related to the first user, and a second set of users that are related to the first set of users. Thereafter, the authors of the user generated responses are intersected with the users related to the first users and the search results authored by the intersection of related users and authors are determined (Step 510). If multiple documents are identified within the search results (Step 512), they may be ranked based on relationship of the nodes (Step 514), as described above with relation to Step 314 of FIG. 3. Finally, the search results are presented (Step 516), as described above with relation to Step 316 of FIG. 3.

### Hardware Overview

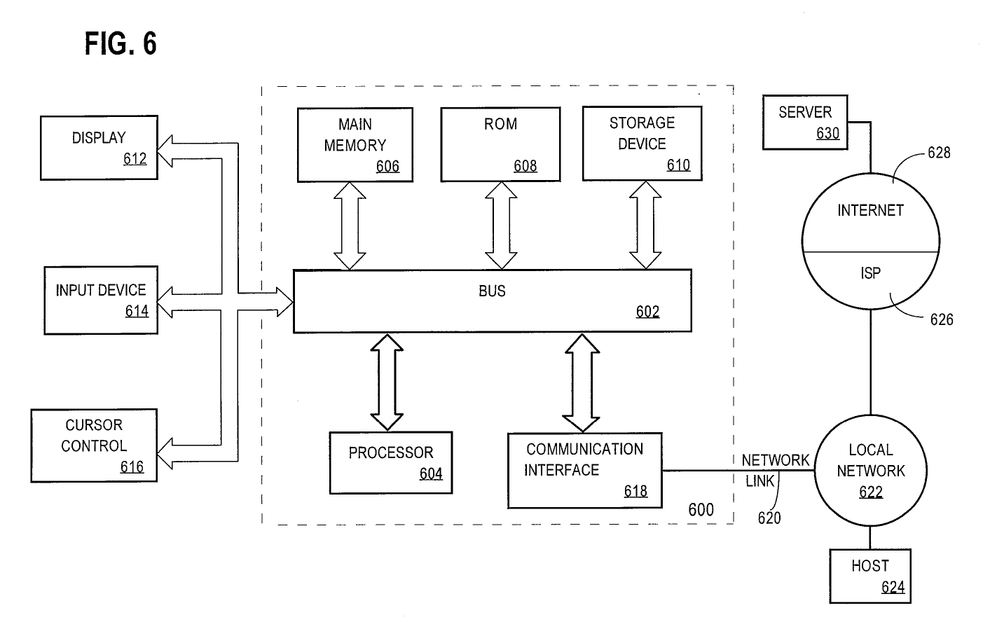

FIG. 6 is a block diagram that illustrates a computer system 600 upon which an embodiment of the invention may be implemented. Computer system 600 includes a bus 602 or other communication mechanism for communicating information, and a processor 604 coupled with bus 602 for processing information. Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

The invention is related to the use of computer system 600 for implementing the techniques described herein. According to one embodiment of the invention, those techniques are performed by computer system 600 in response to processor 604 executing one or more sequences of one or more instructions contained in main memory 606. Such instructions may be read into main memory 606 from another machine-readable medium, such as storage device 610. Execution of the sequences of instructions contained in main memory 606 causes processor 604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 600, various machine-readable media are involved, for example, in providing instructions to processor 604 for execution. Such a medium may take many forms, including but not limited to storage media and transmission media. Storage media includes both non-volatile media and volatile media. Non-volatile media includes, for example, optical or magnetic disks, such as storage device 610. Volatile media includes dynamic memory, such as main memory 606. Transmission media includes coaxial cables, copper wire and fiber optics, including the wires that comprise bus 602. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are exemplary forms of carrier waves transporting the information.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution. In this manner, computer system 600 may obtain application code in the form of a carrier wave.

### Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A machine executed method comprising:
receiving a search request comprising a query term and a context document;
identifying a target document of a plurality of documents based on a relationship of the context document with the target document and the query term, wherein the relationship of the context document with the target document is determined prior to receiving the search request; and
presenting the target document.

2. The method of claim 1, further comprising:
representing each of the plurality of documents with a corresponding node of a plurality of nodes in a linked structure, wherein the context document is represented with a first node in the linked structure, wherein the target document is presented with a second node in the linked structure; and
wherein identifying the target document of the plurality of documents comprises identifying the relationship of the context document with the target document based on the relationship of the first node with the second node within the linked structure.

3. The method of claim 2, wherein the relationship of the first node with the second node within the linked structure comprises:
a graph-based distance of the first node from the second node within the linked structure;
a spectral distance of the first node from the second node within the linked structure;
a common predecessor of the first node and the second node within the linked structure; and
a common successor of the first node and the second node within the linked structure.

4. The method of claim 2, wherein the relationship of the first node with the second node is determined based on a relationship of the first node with a node cluster within the linked structure, wherein the second node is within the node cluster.

5. The method of claim 2, further comprising:
identifying a plurality of target documents based on the query term and the relationship of each the plurality of target documents with the context document, wherein each of the plurality of target documents is represented with a corresponding node in the linked structure; and
ranking each of the plurality of target documents based on a relationship of the first node with the corresponding node of each of the plurality of target documents.

6. The method of claim 1, wherein the relationship between the context document and the target document comprises one or more of:
hyperlinks from the context document that directly or indirectly link to the target document;
hyperlinks from the target document that directly or indirectly link to the context document;
a document access history comprising the context document and the target document;
a common categorization associated with the context document and the target document;
a common author associated with the context document and the target document;
a common time period associated with the context document and the target document; or
a common geographical location associated with the context document and the target document.

7. A machine executed method comprising:
representing each of a plurality of users with a plurality of nodes in a linked structure;
receiving a query term from a first user of the plurality of users, wherein the first user is represented with a first node in the linked structure; and
identifying a search result generated by a second user of the plurality of documents based on the query term and the relationship of the first user with the second user, wherein the second user is represented with a second node within the linked structure,
wherein the relationship of the first user and the second user is identified based on a relationship between the first node and the second node within the linked structure.

8. The method of claim 7, wherein the relationship of the first user and the second user comprises a prior reply generated by the second user in response to a question generated by the first user.

9. A machine-executed method comprising:
receiving training data that includes (a) a plurality of queries and (b) for each query in the plurality of queries, a separate set of search results that was produced based on that query, wherein the separate set of search results comprises a correct target result;
determining a weighted feature vector to rank each set of search results, corresponding to a query of the plurality of queries, that computes a high ranking for the correct target result relative to the set of results that was produced based on that query, thereby determining a plurality of feature vectors;
based on the plurality of feature vectors, determining an optimal feature vector for ranking search results of one or more additional queries.

10. The method of claim 9, wherein the feature vector determined for ranking each set of search results further computes a correct relative ranking between two search results of each set of search results.

11. A computer readable storage medium comprising one or more sequences of instructions, which when executed by one or more processors cause:
receiving a search request comprising a query term and a context document;
identifying a target document of a plurality of documents based on a relationship of the context document with the target document and the query term, wherein the relationship of the context document with the target document is determined prior to receiving the search request; and
presenting the target document.

12. The computer readable storage medium of claim 11, wherein the one or more sequences of instructions, when executed by the one or more processors further cause:
representing each of the plurality of documents with a corresponding node of a plurality of nodes in a linked structure, wherein the context document is represented with a first node in the linked structure, wherein the target document is presented with a second node in the linked structure; and
wherein identifying the target document of the plurality of documents comprises identifying the relationship of the context document with the target document based on the relationship of the first node with the second node within the linked structure.

13. The computer readable storage medium of claim 12, wherein the relationship of the first node with the second node within the linked structure comprises:
a graph-based distance of the first node from the second node within the linked structure;
a spectral distance of the first node from the second node within the linked structure;
a common predecessor of the first node and the second node within the linked structure; and
a common successor of the first node and the second node within the linked structure.

14. The computer readable storage medium of claim 12, wherein the relationship of the first node with the second node is determined based on a relationship of the first node with a node cluster within the linked structure, wherein the second node is within the node cluster.

15. The computer readable storage medium of claim 12, wherein the one or more sequences of instructions, when executed by the one or more processors further cause:
identifying a plurality of target documents based on the query term and the relationship of each the plurality of target documents with the context document, wherein each of the plurality of target documents is represented with a corresponding node in the linked structure; and
ranking each of the plurality of target documents based on a relationship of the first node with the corresponding node of each of the plurality of target documents.

16. The computer readable storage medium of claim 11, wherein the relationship between the context document and the target document comprises one or more of:
hyperlinks from the context document that directly or indirectly link to the target document;
hyperlinks from the target document that directly or indirectly link to the context document;
a document access history comprising the context document and the target document;
a common categorization associated with the context document and the target document;
a common author associated with the context document and the target document;
a common time period associated with the context document and the target document; or
a common geographical location associated with the context document and the target document.

17. A computer readable storage medium comprising one or more sequences of instructions, which when executed by one or more processors cause:
representing each of a plurality of users with a plurality of nodes in a linked structure;
receiving a query term from a first user of the plurality of users, wherein the first user is represented with a first node in the linked structure; and
identifying a search result generated by a second user of the plurality of documents based on the query term and the relationship of the first user with the second user, wherein the second user is represented with a second node within the linked structure,
wherein the relationship of the first user and the second user is identified based on a relationship between the first node and the second node within the linked structure.

18. The computer readable storage medium of claim 17, wherein the relationship of the first user and the second user comprises a prior reply generated by the second user in response to a question generated by the first user.

19. A computer readable storage medium comprising one or more sequences of instructions, which when executed by one or more processors cause:
receiving training data that includes (a) a plurality of queries and (b) for each query in the plurality of queries, a separate set of search results that was produced based on that query, wherein the separate set of search results comprises a correct target result;
determining a feature vector to rank each set of search results, corresponding to a query of the plurality of queries, that computes a high ranking for the correct target result relative to the set of results that was produced based on that query, thereby determining a plurality of feature vectors;
based on the plurality of feature vectors, determining an optimal feature vector for ranking search results of one or more additional queries.

20. The computer readable storage medium of claim 19, wherein the feature vector determined for ranking each set of search results further computes a correct relative ranking between two search results of each set of search results.
